(19) United States
(12) Patent Application Publication
(10) Pub. No.: US 2022/0036395 A1
(43) Pub. Date: Feb. 3, 2022

(54) TEMPERATURE CHECK AND REWARD SYSTEM AND METHOD

(71) Applicant: Wei Chang Jack Huang, Pasadena, CA (US)

(72) Inventor: Wei Chang Jack Huang, Pasadena, CA (US)

(21) Appl. No.: 16/941,551

(22) Filed: Jul. 29, 2020

(51) Int. Cl. G06Q 30/02; G06K 9/00; G01K 13/00

(52) U.S. Cl. CPC G06Q 30/0212; G01K 13/004; G06Q 30/0239; G06K 9/00255

(57) ABSTRACT

A system to provide simultaneous temperature check confirmation and reward signage systems and methods suitable for a retail environment is disclosed. A method provides setting a count value to designate when a reward will be given, obtaining a temperature reading compared against a possible fever threshold, and generating a notification with a snapshot taken at the time when a reward counter reaches its limit while obtaining a temperature reading. A reward system provides a display, a camera, and a reward shown via the display. A snapshot is taken of a guest prior to displaying the reward. A reward counter increments by each facial recognition of a guest. The reward is given when the reward counter reaches a reward winning number. A reward winning number is determined by the sum of the reward nominal number and a random number range.

### BACKGROUND OF THE INVENTION

### 1. Field of Invention

The present invention relates to Class 374, including making a determination of either (1) a characteristic or condition of an object or system utilizing heating or cooling as a significant part of the test and not provided for in other classes, or (2) a thermal quantity or condition; as well as devices with structure unique to a thermal measurement or test and not elsewhere provided for. The present invention also relates to thermometers or thermal measurement devices, rewards, access control systems, and visual display screens.

### 2. Description of the Related Art

Thermometers are known in the related art. Conventional thermometers are contact-based. For example, U.S. Pub. No. 20020001335 to Lee for “Medical thermometer” filed on Aug. 27, 2001 discloses a contact-based medical thermometer for measuring the temperature of a patient comprises a metal tip with an outer contact surface for contacting the tissue of a patient. However, Lee and conventional thermometers do not teach or suggest a system for access control or reward systems, nor is there any teaching or suggestion to try or to combine such technologies.

Handheld thermometers are known in the related art. For example, U.S. Pub. No. 20080075141 to Weng, et al. for “Infrared Clinical Thermometer” filed May 22, 2007 to Weng, et al. discloses a push-button activation mechanism and built-in display in the casing. However, Weng, et al. and conventional handheld thermometers are generally not coupled with reward systems and are not practical for repeated uses in retail environments which requires significant labor. Nor is there any teaching or suggestion to try or to combine thermometers, access control and reward systems.

Contactless thermometers are also known in the related art. For example, U.S. Pub. No. 20090304042 filed Jan. 12, 2009 to Agronin discloses an infrared method of taking temperature. However, Agronin and conventional contactless thermometers are generally not coupled with reward systems and are not practical for repeated uses in retail environments which requires significant labor.

Access control methods using cameras are known. For example, Trell (U.S. Pub. No. 20150341336) discloses an access control system involving interaction with a camera with an access code such as a QR code. Mizon (U.S. Pub. No. 20120068818) discloses access control via code to mobile phone including to control access to an elevator. However, Trell and Mizon and conventional access control systems do not have temperature sensors to perform fever detection; and are not coupled with a retail reward-based system.

It can be seen then, that there is a need for a system to address the foregoing needs and to provide a technology that is capable of providing customer engagement opportunities and positive reinforcement via rewards and coupons. It can also be seen that there is a need for such a system to provide configurable settings for a retailer to manage promotional frequency of such rewards to guests which engage with the display and also can turn a required temperature check for entry into an opportunity to positively engage the customer. Furthermore, it can be seen that there is a need to address any combination of the foregoing needs alone or in combination.

### SUMMARY OF THE PRESENT INVENTION

The present invention seeks to resolve the shortcomings of conventional reward systems and retail technology systems to provide an engaging reward system.

The present invention can also encourage use of fever detection systems thereby helping to prevent the spread of infectious disease, thereby assisting in curbing the spread of COVID-19 and other disease.

The present invention provides a system to provide simultaneous temperature check confirmation and reward signage suitable for a retail, hospitality or other environments.

An aspect of the present invention is to provide opportunities for positive customer engagement or repeat business, for example, by offering a chance to win, or actually winning, a prize or other reward.

Another aspect of the present invention is, simply, to have fun—by creating positive reinforcement while interacting with an organization. This can include activities such as fever detection at a physical transition point; a few examples being: retail shops, hotels, sports stadiums, convention centers, or for the purchase of goods or services, whether upon entry, during a visit, or exit.

An additional aspect of the present invention is to provide a technology that is capable of creating opportunities to engage a customer by notifying a manager who can engage on a human level instead of relying solely on automation, thereby creating an enriched personal interactive experience.

Still yet another aspect of the present invention is to address the needs of public health (especially critical during a public health crisis or pandemic), retailer marketing, and customer engagement simultaneously—with the understanding that fever detection alone can be off-putting to customers without a positive experience which is missing from conventional thermometer technologies.

Still yet another aspect of the present invention is to permit organizations using the present invention to specify the frequency and nature of the reward.

### BRIEF DESCRIPTION OF THE DRAWINGS

Non-limiting exemplary embodiments are provided in the drawings as follows:

FIG. 1 is an embodiment of a method of the present invention at startup time;

FIG. 2 is an embodiment of a method of the present invention at configuration time;

FIG. 3 is an embodiment of a method of the present invention;

FIG. 4 is an embodiment of a method of the present invention.

FIG. 5 is an embodiment of a system of the present invention;

FIG. 6 is an embodiment of a system of the present invention;

FIG. 7 is an embodiment of a system of the present invention; and

FIG. 8 is an embodiment of a system of the present invention; and

FIG. 9 is an embodiment of a system of the present invention.

### DETAIL DESCRIPTION OF THE PREFERRED EMBODIMENTS

In the following description of the preferred embodiments, reference is made to the accompanying drawings that form a part hereof, in which is shown by way of illustration specific embodiments in which the invention may be practiced. It is to be understood that other embodiments may be utilized and structural changes may be made without departing from the scope of the present invention.

References throughout the specification to “interesting embodiment”; “possible embodiment”; “preferred embodiment”; “some embodiments”; “an embodiment”; and like reference to “embodiment” are non-limiting examples to aid in understanding the present invention. An “embodiment” provides that there can be one or more embodiments that can involve the given element or aspect of the invention. Thus, multiple instances of “an embodiment” and like reference do not necessarily refer to the same embodiment.

This specification provides for specific meanings with respect to the present invention, the meanings of which shall be understood as follows:

The term “can” is to be understood as non-limiting and is to be construed as illustrative of a possible embodiment of the present invention.

“At or below” or “at or above” in reference to temperature reading or other values need not be strictly construed for purposes of understanding how to implement the invention and should be construed as non-limiting examples. “Manager” can refer to supervisor, customer support, customer relations, store ambassador, guest relations, or worker. When used in the context of the present invention, notification to manager can refer to a message electronically delivered to a manager's mobile or computing device.

“Temperature scanner 301” or “scanner 301” can refer to the same as used herein.

“Participant”; “customer”; “guest”; and “shopper” are interchangeable for purposes of this specification and can ultimately be understood to refer to snapshot 307 of an individual.

Only after reviewing the disclosures of this specification would it be obvious to one having ordinary skill in the pertinent art to understand how to make and use the invention consistent with the teachings of the present invention.

FIGS. 1 through 4 show non-limiting illustrations of possible methods of the present invention. FIG. 1 is an embodiment of a method of the present invention at startup time. FIG. 2 is an embodiment of a method of the present invention at configuration time. FIGS. 5 through 8 show non-limiting illustrations of possible implementations of systems of the present invention. The drawing figures are non-exhaustive and it can be seen that many variations to implement the present invention are possible in light of this specification.

By way of non-limiting illustration, the present invention can provide the following steps: providing power to display 200; turning on the display 200; running a self-diagnostic check on the system; setting reward counter 102 (step 1000 is shown in FIGS. 1 and 3); setting or resetting reward nominal number 900 (step 2000 in FIG. 2); guest approaches display 200 (step 3000 in FIG. 3); increment reward counter toward reward winning number 100 (step 3006 in FIG. 3); check whether reward counter 102 is equal to reward winning number 100 (step 3007 in FIG. 3); setting, or resetting, reward counter 102 (step 1000 in FIG. 3); camera 502 takes snapshot 307 of guest 300 (3008 in FIG. 3); and notifying guest 300 of reward 310 (3009 in FIG. 3).

By way of non-limiting illustration, the present invention can also provide the following steps for temperature checks: providing power to display 200; turning on the display 200; running a self-diagnostic check on the system; setting reward counter 102 (step 1000 is shown in FIGS. 1 and 3); setting or resetting reward nominal number 900 (step 2000 in FIG. 2); guest approaches display 200 (step 3000 in FIG. 3); obtaining temperature of guest 300, preferably by scanning via scanner 301 (step 3001 in FIG. 3), which can optionally be used in conjunction with camera 502 and display 200; checking temperature reading 304 against a preconfigured possible fever threshold 104 (step 3002 in FIG. 3); notifying manager of possible fever indicator 600 and snapshot 307 of guest 300 (step 3003 in FIG. 3); provide intervention notification 302 to guest 300 via display 200 (step 3004 in FIG. 3); report temperature reading 104 with or without a message (step 3005 in FIG. 3); increment reward counter toward reward winning number 100 (step 3006 in FIG. 3); check whether reward counter 102 is equal to reward winning number 100 (step 3007 in FIG. 3); setting, or resetting, reward counter 102 (step 1000 in FIG. 3); camera 502 takes snapshot 307 of guest 300 (3008 in FIG. 3); and notifying guest 300 of reward 310 (3009 in FIG. 3).

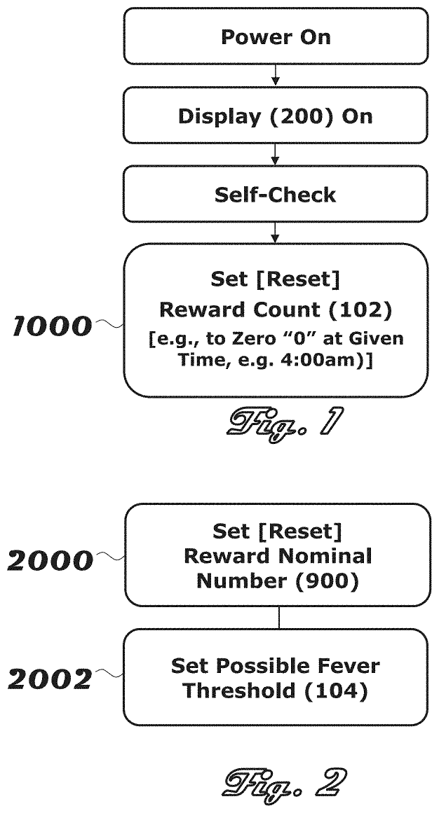

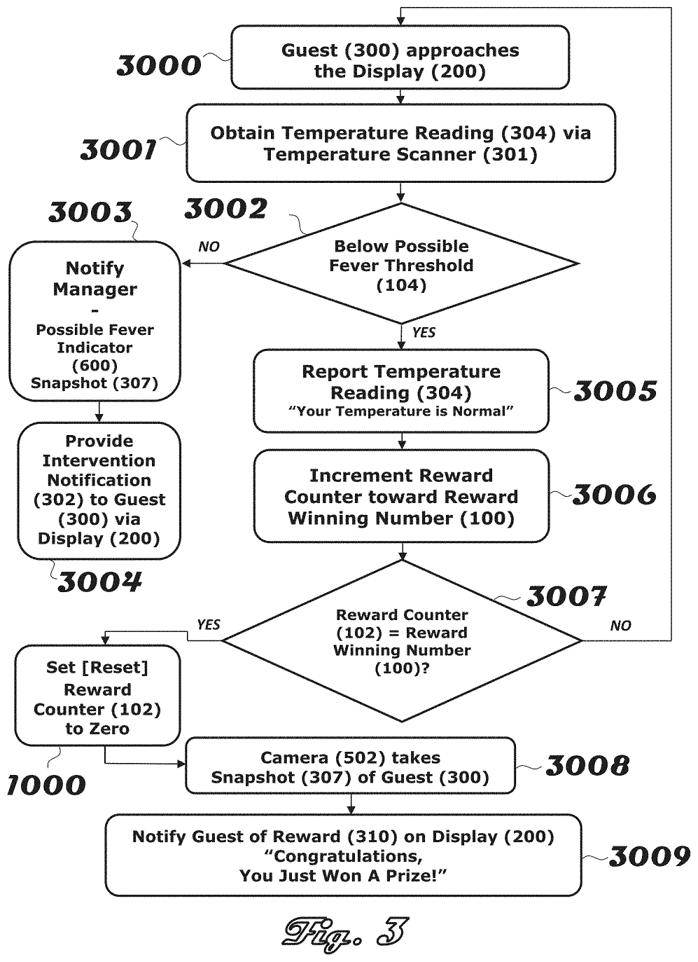

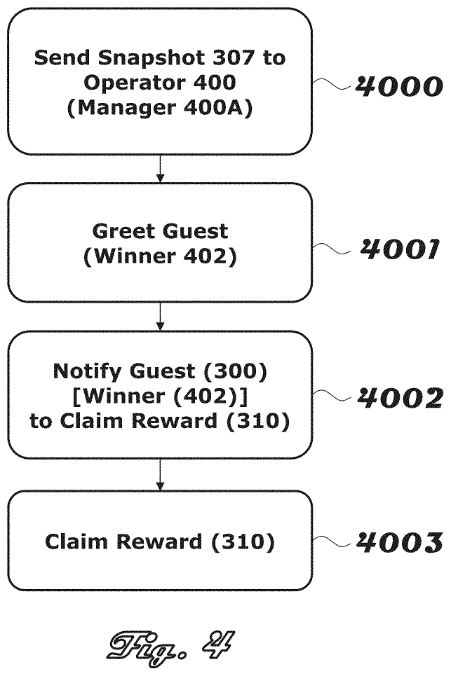

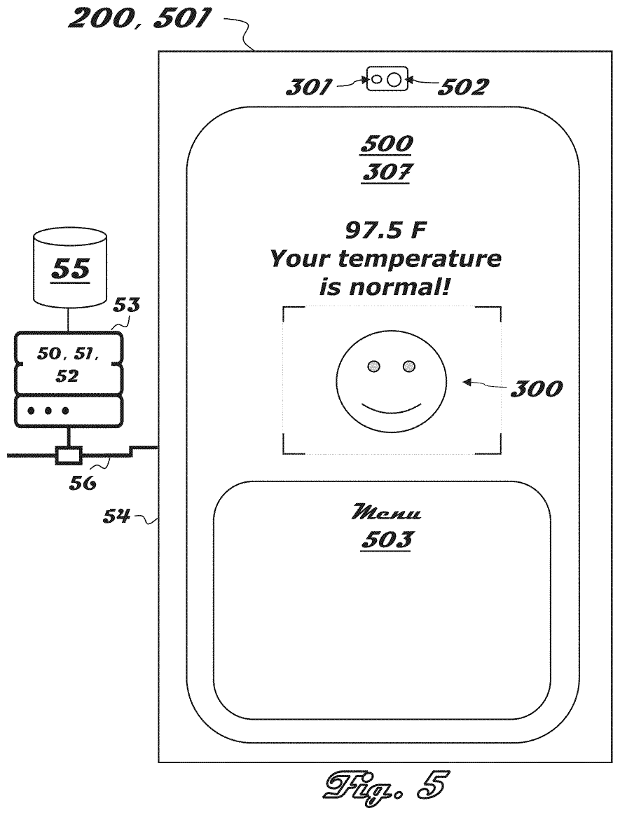

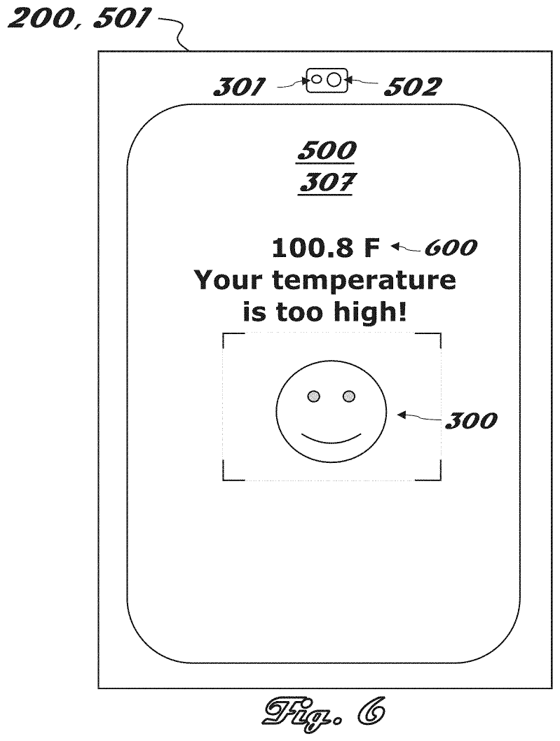

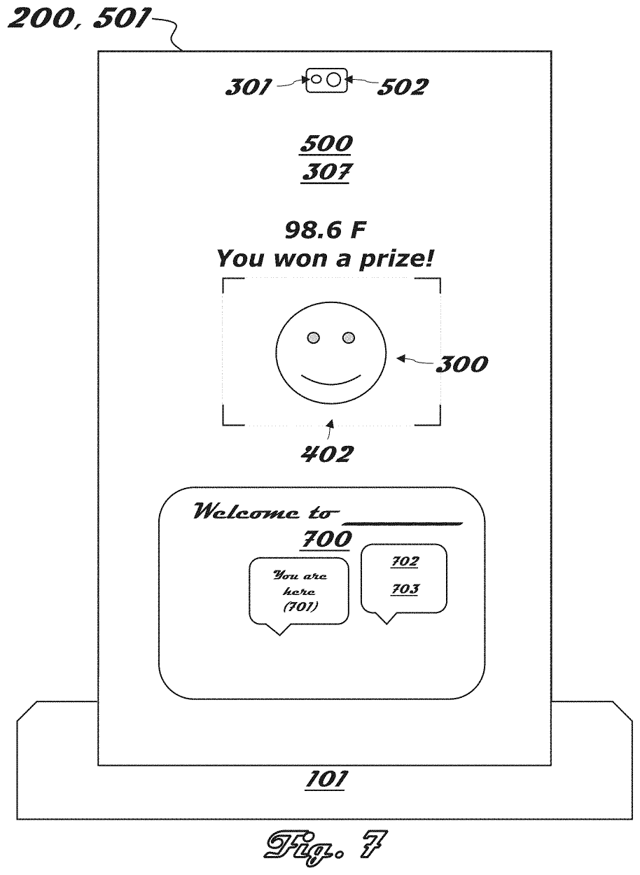

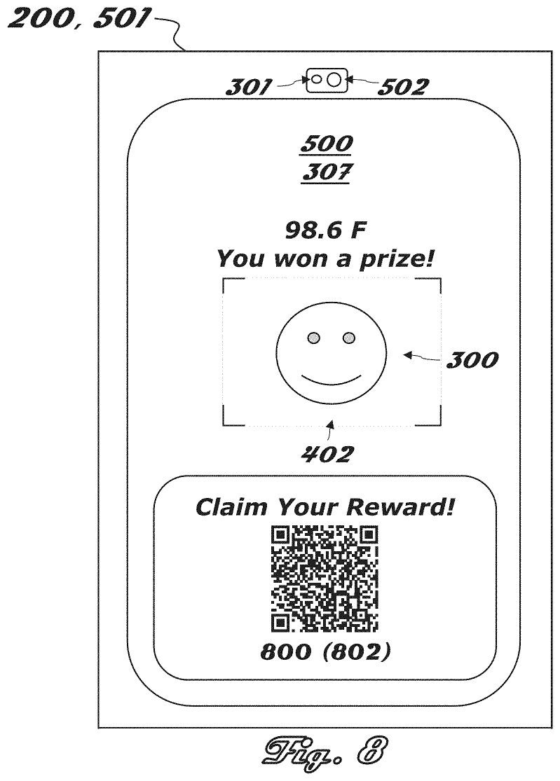

Display 200 can be a tablet. Display 200 can be used by a guest by simply standing in front of display 200 and temperature scanner 301 activates to register temperature of the guest. Scanning to obtain (step 3001 in FIG. 3) temperature reading 304 can occur prior to, during, or after entry to a given location by obtaining temperature reading (steps 3000, 3001, 3002). In a possible embodiment, display 200, camera 502 and temperature scanner 301 can be housed by an enclosure, or in separate module. In some embodiments, display 200 can flash a color while temperature check is being performed. Calibration of temperature can be performed prior to letting the system run. Display 200 can provide digital menu boards can be outside of the restaurants to attract passers-by. In some smaller embodiments, such as tablet embodiments, display 200 can be provided with support 101 (FIG. 7). Support 101 can be, for example, a table, floor stand, or any mountable object upon which display 200 can be set upon. If a guest is suspected of having a fever, the guest can be denied admittance or entry to a particular establishment, which can occur upon receiving a possible fever indicator 600, by way of non-limiting illustration, to notify a particular guest “Your temperature is too high”; or “Please see manager. Sorry, entry denied.” (FIGS. 3 and 6). The intervention notification 302 can be communicated via display 200. In some embodiments, display 200 can be larger than tablet, flatscreen, kiosk, without limitation as to a particular size. In larger embodiments, a greater viewable area can show additional information via display 200. In some embodiments, display 200 can have operating system 50 with processor 51, memory 52, server 53, client 54 and database 55 (FIG. 5). Server 53 and client 54 can communicate to send and receive information from camera 502 and scanner 301. In most preferred embodiments, display 200 can be within housing 501 (FIG. 5). In some preferred embodiments, also within housing 501, there can be processor 51, memory 52, and database 55 (FIG. 5). In most preferred Internet-enabled embodiments, there can be a connection 56 (FIG. 5) which can be wired or wireless, most commonly via Wifi, Bluetooth, Zigbee, or any other wireless data communications protocol, via Internet, or any combination thereof. Connection 56 can permit connectivity to activate and distribute reward 310 on an external rewards website URL 202. Internet enablement need not be activated to provide a QR code to a reward recipient. A reward receipt can be printed through a wired or wireless local printer. In some embodiments, reward codes can be preloaded via a unique encryption key and stored remotely on server 53. Not all embodiments of the present invention need to rely on a remote server 53. It can be seen that the present invention can be implemented without client-server technology and a rewards website URL 202 can operate without same. In such embodiments, snapshots 307 for purposes of providing reward 310 can be stored locally instead of on server 53.

Reward counter 102 can count the number of guests 300 before reward 310 is issued. In a possible embodiment, reward counter 102 can be initialized at zero “0”, and can be reset to zero “0” each time RWN 100 is reached. By Reward counter 102 can increment a number until reward counter 102 reaches reward winning number 100, then reward 310 is awarded. In some embodiments, reward winning number 100 can be a summation of operator's preset reward nominal number 900 and a randomized, i.e., set to generate a random value, instead of using a preset fixed number which is susceptible to predictability. Reward nominal number 900 can be preset by operator 400. When reward winning number 100 is reached by reward counter 102, sign 500 can declare winner 402 (FIG. 7). Reward winning number 100 can be stored in database. Reward winning number 100's value can have a preset limit. In a possible embodiment, reward counter 102 can be initiated to zero “0” at 4:00 am each day (FIG. 2). Reward counter 102 can increase by one (1) after each guest's temperature scan. In other embodiments, reward counter 102 can increment when guest 300 views menu board, or views or uses a directional map. Each time reward counter 102 reaches the reward winning number 100, reward counter 102 can reset back to zero “0” (FIG. 3). Reward counter 102 can increment by one again, per each person, thereby counting toward the next reward winning number 100. In some other possible embodiments, reward winning number 100 can be determined by a predetermined countdown instead of incrementing upward; the result is the same. It can be seen that the present invention can have widely varying mathematical variations while still embodying the spirit of the present invention.

“Set reward counter” 1000 can occur at startup time. “Set reward counter” 1000 can set reward counter 102 to zero “0” at a given time, e.g. 4:00 am.

“Set reward nominal number” 2000 (FIG. 2) can occur at configuration time.

Configuration time can occur during runtime. Operator 400 can set the value of reward nominal number 900. In a possible embodiment, operator 400 can set reward nominal number 900 to a single number. By way of non-limiting illustration, reward nominal number 900 can be set to a singular number; by way of non-limiting illustration, reward nominal number can be set to “10”, “50”, or “100” or any other single number. A random value can be generated to add to reward nominal number 900, to produce the reward winning number 100. By way of non-limiting illustration, in a possible embodiment, reward winning number 100 can also have a range of plus or minus for an upper limit and a lower limit; for example, +1-5. The range can be added to reward nominal number, e.g. “10”, “50”, or “100” or any numeric value; In a possible embodiment, operator 400 can set reward nominal number 900, combined with at least one or more random values which can be randomly generated, to produce random number range 902 for reward winning number (reference numeral 100) as discrete values; for example between “5 to 15”. Thereby, if reward nominal number (reference numeral 900) can be set to the value of “50” and the random number range 902 is set to “−5 to +5”, then the reward nominal number 900 and random number range 902 are added together producing possible outcomes as shown by the following non-limiting illustration: 50−5=45 as the lowest possibility in this example, and 50+5=55 as the highest possibility in this example. In a possible embodiment, if reward nominal number (900) is set to 100 and the range is set to “−5 to +5”, then the outcome can be between 100−5=95 (lower limit) to 100+5=105 (upper limit), inclusive.

“Set possible fever threshold” 2002 (FIG. 2) can occur at configuration time whereby a numeric value and temperature unit of measure such as Fahrenheit or Celsius can be set for possible fever threshold 104.

The following example shows a non-limiting illustration of how to obtain a reward winning number 100. By way of non-limiting illustration:

Reward nominal number 900 (“RNN”) can be any singular number. By way of non-limiting illustration, RNN 900 can be “10”, “50”, or “100” or any other singular number, such as an integer or other non-integer real number. RNN 900 can be set by operator 400.

Random number range 902 (“RNR”) can be a set of numbers with an upper and lower limit. By way of non-limiting illustration, RNR 902 can set an upper and lower limit for a range of numbers to define the range such as plus or minus five (+/−5), namely, −5, −4, −3, −2, −1, 0, 1, 2, 3, 4, 5. In this non-limiting example, random number range 902 can be negative five to positive five. Random numbers can be generated by programming languages. In a possible embodiment, a random number generator can provide random number range 902. A random number generator can provide random number range 902. A person having ordinary skill in the pertinent art would know how to generate random number range using a programming call to generate a random number.

Reward winning number 100 (RWN) can be the result of combining reward nominal number 900 and random number range 902. In other words, RWN 100 can be determined by adding reward nominal number 900 plus random number range 902. A benefit of RWN 100 can be to provide both fixed or in a range of numbers for variation and excitement.

In a possible embodiment, RWN 100 can be determined as reward nominal number, set by operator 400, to “10” plus RNR (900) set to +/−5 and thereby RWN will be in the range of 5 to 15. By way of non-limiting illustration, if RNN 900 is set to “10” and RNR 902 is set to “+/−5” then the possible outcomes of RWN 100 can be: 5, 6, 7, 8, 9, 10, 11, 12, 13, 14, and 15. By way of non-limiting illustration, if RNN 900 is set to “50” and RNR 902 is set to “+/−5” then the possible outcomes of RWN 100 can be: 45, 46, 47, 48, 49, 50, 51, 52, 53, 54, 55. By way of non-limiting illustration, if RNN 900 is set to “100” and RNR 902 is set to “+/−5” then the possible outcomes of RWN 100 can be: 95, 96, 97, 98, 99, 100, 101, 102, 103, 104, and 105.

For example, if an operator sets the reward nominal number RNN value to “10” with the RNR 902 of −5 to +5, reward winning number 100 will be in the range of 5 to 15.

The term “around” when referring to the reward nominal number 900, random number range RNR 902, or reward winning number RWN 100 can be ascertainable by adding a random number generator. Thereby, there is a known plus or minus range that limits the set of potential numbers in relation to reward nominal number 900. A person having an ordinary level of skill in the pertinent art would understand how to apply the teachings the present invention without undue experimentation. A person having an ordinary level of skill in the pertinent art would understand that the median value of random number range 902 need not have a median equal to the value of the random nominal number 900. By way of non-limiting illustration, the upper and lower limits inherent in the range of random number range 902 can have different numeric values such as −2 and +7 instead of +/−2.

By way of non-limiting illustration, to reward around the 50th person, a random number range 902, can be added to the reward nominal number 900 of “50”, to obtain a reward winning number around the 50th person. In this example, if operator 400 sets reward nominal number 900 equal to “50” with the random number range of “−5 to +5” the RWN 100 will be in the range of “45 to 55.” In this example, if the operator sets reward nominal number 900 to “100”, then with random number range 902 from −5 to 0 to +5, reward winning number 100 can be in the range of 95 to 105.

One of ordinary skill in the pertinent art would know how to implement reward winning number 100 based on the present specification without undue experimentation.

Scanned guest or guest 300 can refer to a scanned individual and can include scanning results in connection with the scanned guest 300. Scan 3001 can include a temperature scan. In some possible embodiments, scan 3001 can be performed via scanner 301 to detect the presence of a moving object. Once the presence of a moving object is sensed, there need not be a specific guest but rather the object motion detection can trigger the display of reward 310.

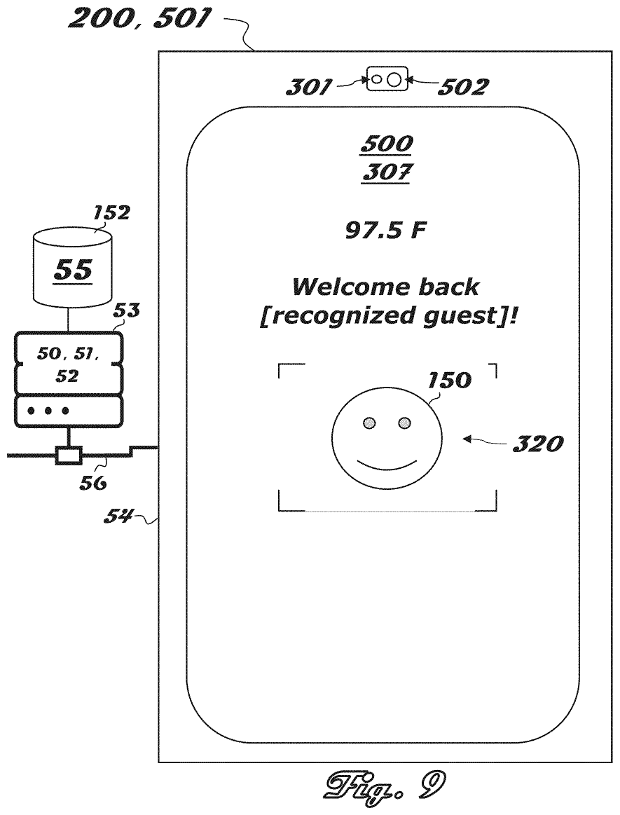

Reward 310 can be shown on display 200. Reward 310 can be provided with smart feedback to help guests locate stores and/or restaurants, for example, on a map. Reward 310 can be provided to every Nth customer according to reward winning number 100. In some embodiments, reward 310 can be randomly awarded, or periodically by reward winning number 100. Reward 310 can be informed to customer after temperature check is performed. Reward 310 can be based on reward winning number 100. Reward 310 can provide a prize, coupon, gift, loyalty points, or incentive. By way of non-limiting illustration, reward 310 in coupon form can provide a coupon to participating stores or restaurants, meal, item, discount, special offer, free parking, valet parking. Reward 310 can be localized for a nearby location within a given distance. Reward 310 can provide for redemption with a restaurant, retail store, club, or business. Reward 310 can provide for a location within a given distance. Reward 310 can be set for a future date and or time. Reward 310 can be deemed within a prescribed time frame to encourage purchasing decisions. Reward 310 can be distinguished from receiving email discount codes or coupons which are used at distance or used in virtual stores. One having ordinary skill in the pertinent art would understand how to make and use reward 310 consistent with the teachings of the present invention for a localized retail experience. In some embodiments, reward 310 can be obtainable by a QR code 800 (FIG. 8) which can encode reward website URL 802 (FIG. 8). In some embodiments, reward 310 can be issued to guest 300 without obtaining temperature reading 506. Reward 310 can be issued without scanning 3001, for example, by looking at sign 500. Reward 310 can be issued without scanning 3001 by presence of guest 300 in front of camera 502 by looking at menu 503 (FIG. 5) or map 700 (FIG. 7). In some embodiments, reward 310 can be presented without image of guest 300 and without snapshot 307. Reward 310 can be obtainable by an at least one selected from: a QR code 800, an electronic notification which can be via text, email, browser, mobile app, code, or a printed receipt.

In embodiments with temperature scanner 301, temperature scanner 301 can be a temperature measurement device, preferably a contactless thermometer providing temperature reading 600. Scanner 301 can be built into housing 501 with display and camera 502. Rather than using a handheld thermometer, obtaining temperature reading 304 can be shown on the screen of display 200. Scanner can be activated to work simultaneously with camera 502 in most preferred embodiments. A benefit of scanner 301 is to perform temperature check and thereby to detect a potential fever of a particular guest. Scanner 301 can conduct multiple temperature recognitions simultaneously. In a possible embodiment, scanner 301 can have camera 502 with one or more guests 300 and snapshot 307 can capture multiple temperature readings 600 rapidly in real time or near real time. Scanner 301 can have an emitter and a reader. Emitter can have a light source or radiate non-visible frequency. In some embodiments, reader can be camera 502.

Scanner 301 (FIGS. 5-8) can check for fever by radiating an emitter consistent with contactless thermometer technology. Obtaining temperature reading 304 can occur via scanner 301 in real time. Scanner 301 can instantly check against possible fever threshold 104.

Intervention notification 302 can be provided via display 200. Intervention notification 302 can be sent to a predesignated recipient upon instruction via an input command. Display 200 can show and also provide an alternative reward 310 for a guest with potential fever to seek to address social dynamics associated with a particular guest with possible fever indicator 702.

Temperature reading 304 (FIG. 3) can be the instance of a given guest's temperature as determined by scanner 301. Temperature reading 304 can be shown on display 200.

Snapshot 307 can refer to an image and can have associated metadata of the name of the establishment to whom the system is registered, manager, date, time, camera, temperature reading 304, and possible fever threshold 104. Snapshot 307 can be taken of guest 300 with an associated temperature reading 600. Snapshot 307 can have an associated temperature reading 600.

Possible fever threshold 104 can be configurable in the system. Possible fever threshold 104 can be set to any temperature. In a preferred embodiment, by way of non-limiting illustration, possible fever threshold 104 can be set to “100.4 degrees Fahrenheit” which is consistent with Centers for Disease Control. A benefit of possible fever threshold 104 can be to allow for variance in temperature depending on the weather; for example, on hot days, temperature may be slightly higher and therefore screening via possible fever threshold 104 can be adjusted to a higher value. In a possible embodiment, temperature checks can avoid storing cleared persons and can provide snapshot 307 of a person who has not cleared temperature check according to the preset possible fever threshold 104. Thereby, a benefit of the present invention can be to alert and initiate further action to address the individual.

Ambient temperature 111 can be measured generally by scanner 301. Ambient temperature can permit more effective calibration of scanner 301 with possible fever threshold 104.

Sign 500 can be provided on display 200. Sign 500 can provide indication of reward 310. Sign 500 can provide map 700. By way of non-limiting illustration, sign 500 can provide map 700 with local shops 702 and menu board 702 displayed next to map 700. In embodiments with local shops 702 as restaurants, restaurants can include by way of non-limiting illustration, food markets, bars, cafes, diners, coffee shops, popups, food trucks, or other eateries. There can be one or more signs 300.

Housing 501 (FIG. 5) can provide display 200. Housing 501 can be mounted on any surface, by way of non-limiting illustration, a table, stand, fence, kiosk, enclosure, menu, lobby, or other proximate location in or around the entry are of a given establishment. Housing 501 can be provided on support 101.

Camera 502 can be a camera connected with display 200. In some embodiments, display 200 can have camera 502 built in, as with tablets or larger screens. In most preferred embodiments, scanner 301 can conduct obtaining temperature reading 3001 of groups of people at a time simultaneously. Camera 502 can take a snapshot 307 of a guest 300 or of a person with possible fever indicator 600 resulting from scanning 301 to check temperature via scanner 301. In some possible embodiments, camera 502 can be coupled with temperature scanner 301. Many cameras are known in the related art, including by way of non-limiting illustration, Ring, Logitech, Cognex, Keyence, Dahua, Hikvision, and Matrox and Omron.

Possible fever indicator 600 (FIGS. 3 and 6) can indicate possible fever when temperature is at or above the possible fever threshold 104. Possible fever indicator 600 can be shown in display 200. Possible fever indicator 600 can be sent to one or more pre-designated recipients, such as operator 400.

Physical location 701 (FIG. 7) can be referred to virtually as a point of reference. Physical location 701 can be displayed via sign 500 or map 700 (FIG. 7). Physical location 701 can refer to any physical passage space, including but not limited to large walkways or more constrained one-by-one passthrough areas whereby access control can be implemented via the present invention. The present invention can be implemented at access control locations, including by way of non-limiting illustration: entrance, lobby, security check, temperature check, turnstiles, gates, doors, boarding areas, doorways, hallways, and other entry areas, checkpoints or walkways.

Map 700 can have local shops 702. In some embodiments, map 700 can be helpful in a shopping area. Map 700 can be shown on display 200 or more specifically on sign 500.

Local shops 702 can be shown on map 700. Local shops 702 can be added to database 55 having reward vendors 703 providing rewards 300.

Winner 402 can be a guest 300. Winner 402 can refer to a guest 300 whose temperature reading 304 or snapshot 307 is associated with reward 310. Winner 402 can be identified by snapshot 402 at the time reward 310 is determined by reaching the numeric limit set by reward winning number 100. Winner 402 can be presented with reward 310 via sign 500 on display 300. In some embodiments, a QR code can be generated to thereby provide reward 310.

In a method of the present invention, the following steps can occur, by way of non-limiting illustration:

Set reward nominal number 900 can occur (FIG. 2). Setting reward nominal number 900, and combined with random number range 902, to produce the next reward winning number 100. Counter will increase by “1” per guest, until the reward winning number 100 is reached, which can determine when reward 310 will be given. For example, operator 400 can set a value for reward nominal count of 90 upon which to give a reward after 90+/−5 number of temperature readings are taken. Guest 300 can be in front of display 200 where scanner 301 operates to obtain temperature reading 304 (FIG. 3) of guest 300 and can check against possible fever threshold 104 to determine if guest 300 is acceptable or to notify manager 3002 with possible fever indicator 600 of guest 300 with snapshot 307 (FIG. 3). Display 200 can simultaneously show the guest on camera 502 and the result of scan 301 as temperature reading 304 can be shown on display 200. After temperature check is completed via scan 301, if temperature reading 304 is at or below the temperature threshold, the system can report temperature reading 3005. Reward counter 102 can be checked to determine if there is winner 402, and when the count reaches the reward winning number 100, snapshot 307 can be taken. Reward counter 102 can be reset periodically, or back to “zero,” after each reward winning number is reached, for example, on a daily basis, or other periodic time increment. Setting reward nominal number 900 can designate when a reward will be given can be made after reward winning number 100 of temperature readings are taken.

Set possible fever threshold 2002 (FIG. 2) can occur at any time during configuration prior to subsequent scanning 3001. In this step of setting possible fever threshold 2002, operator 400 can input a value for possible fever threshold 104.

Guest 300 approaches display 200 (step 3000 in FIG. 3) can occur. Guest 300 can be in view of camera 502 or scanner 301 or preferably both camera 502 and scanner 301 prior to scanning 301 and obtaining temperature reading 304. Guest 300 can be in range of scanner 301. Guest being in range of scanner 301 can trigger scan 301 to begin the step of obtaining temperature reading 3001 via temperature scan 301.

Obtain temperature reading (step 3001, FIG. 3) can occur by conducting temperature scan 3001 via scanner 301 on guest 300.

Check whether temperature reading is below possible fever threshold 104 can occur (step 3002, FIG. 3). The temperature of the guest can be compared to the possible fever threshold 104 to determine if the temperature reading is below temperature threshold 104 or not.

Notify manager (step 3003, FIG. 3) can occur, with or without possible fever indicator 600, preferably with snapshot 307. Reward 310 can be shown on display 200 indicating the guest won reward 310, such as a prize, coupon, gift, loyalty points, or incentive. Notify manager 3003 can provide snapshot 307 and temperature reading 304. Possible fever indicator 600 can be sent to a manager by notifying manager 3002. when the condition for possible fever is triggered when obtaining temperature reading 304. Notify manager 3003 can simultaneously include a snapshot 307 of winner 402 and temperature reading 304 of guest 300 as winner 402. A possible benefit of notifying manager 3003 can be to provide an opportunity for evaluation by a human, such that the present invention assists humans in evaluating appropriate steps and addressing social dynamics which can vary widely and may not be appropriate for pure automation.

Provide intervention notification 302 can occur (step 3004, FIG. 3). Intervention notification 302 can be sent to a predesignated recipient such as manager 400A or guest 300. In a possible embodiment, intervention notification 3004 can have snapshot 307 and possible fever indicator 600.

Report temperature reading 304 can occur (step 3005, FIG. 3). Report temperature reading 3005 can indicate acceptable temperature or a possible fever based on possible fever threshold 104. Possible fever indicator 600 can be generated thereby. Reporting temperature reading 3005 can indicate the temperature is clear or otherwise verified. In a possible embodiment, reporting temperature reading 3005 can indicate temperature reading 304 by notifying manager (step 3003, FIG. 3) or guest (step 3004, FIG. 3). Report temperature reading 3005 can occur after or before checking whether temperature reading 304 is below possible fever threshold 104.

Increment reward counter 102 toward reward winning number 100 can occur (step 3006, FIG. 3). Increment 3006 can add a numeric value of plus 1 to reward counter 102, progressing the current numeric value of reward counter 102 toward reward winning number 100. Reward counter 102 can be not incremented when guest 300 is a recognized guest 320 (FIG. 9) during a time limit. After the time limit expires, the same guest can be counted by reward counter 102.

Check whether reward counter 102 is equal to reward winning number 100 (step 3007 in FIG. 3) can occur. If reward counter 102 reaches reward winning number 100, then proceed to reset reward counter 102 (step 1000, FIGS. 1 and 3) and camera takes snapshot of guest (3008, FIG. 3).

Camera takes snapshot of guest (step 3008 in FIG. 3) can occur. Taking snapshot 3008 can be accomplished by recording a still image, photo burst, or video of a guest 300 via camera 502 taking snapshot 307. Snapshot 307 can be sent to manager 400A, or stored in database 55 (FIG. 5). Take snapshot (step 3008, FIG. 3) can be used to provide reward 310 to a particular guest 300. In a preferred embodiment, reward 310 can be provided to guest 300 after scanning 3001 and upon reaching the value of reward winning number 100.

Notify guest of reward 310 (step 3009 in FIG. 3) can occur after the number of scanned guests reaches the preset limit of reward winning number 100. In most preferred embodiments, notify guest of reward 3007 can facilitate an opportunity for a manager to present reward 310 to winner 402. QR Code 800 (FIG. 8) to access reward can be shown in display 200. Notifying guest of reward 3007 can be triggered by reward winning number 100 where winner 402 is determined by reward counter 102 for temperature reading 304.

Send snapshot (step 4000 in FIG. 4) can occur. A recipient can be designated. In a possible embodiment, operator 400 can be designated, or manager 400A can be designated manager other than operator 400, to differentiate a role from operator 400 wherein the manager 400A can set temperature and reward policies at configuration time. A benefit of having manager 400A as a distinct role is to provide manager 400A with focus on interfacing with guests that win reward 310; or intervening with a particular guest 300 associated with possible fever indicator 600 shown in snapshot 307.

Greet guest (step 4001 in FIG. 4) can occur through the present invention. A benefit of this step of the present invention is to create an opportunity to interface with guest 300 through personal interaction, thereby leveraging technology for customer engagement. In a possible embodiment, greet guest can be performed by the system via display 200. In most preferred embodiments, greet guest 4001 can occur by facilitating human interaction with a notification to a recipient assigned to greet a guest 300, which can be winner 402 but need not be limited only to winner 402.

Notify guest to claim reward (step 4002 in FIG. 4) can occur via message in display 200, or manager's smart device, or alternatively in conjunction with the step of greet guest 4001. QR code 800 to winner 402 can be generated with a unique identifier to claim reward 310. QR code 800 can be shown in display 200 with a request to claim reward 310.

Claim reward 310 (step 4003 in FIG. 4) can occur by winner 402 visiting a URL to obtain reward 310 or alternatively when reward 310 is presented to winner 402 to permit reward 310 to be obtainable. Claim reward 4003 can occur by visiting the URL in a browser.

QR code 800 (FIG. 8) can encode a URL. QR code 800 can be presented to claim a given reward 310 by winner 402. By way of non-limiting illustration, QR code 800 can include for example the reward website with attributes and values to be set by then-generated code such as <rewardwebsitedomain.com?rewardURL=1&date=_&time=_&reward_id=_&temp=&location=_&managerpublickey=_>. Thereby a public key does not reveal the private key to ensure secure delivery with a further hash key to enhance security and prevent unauthorized access even with access to the public key. Rewards website URL 802 can provide the uniform resource locator for a website reachable over the Internet.

Facial detection 150 (FIG. 9) can be obtained via camera 502 of guest 300. Facial recognition data 152 (FIG. 9) can be stored in database 55. Facial detection 150 of the guest 300 is obtained. Facial detection 150 is checked against database 55 having facial recognition data to determine whether data from the facial detection 150 is recognized guest 320. If not, reward counter 102 can increment. However, if guest 300 is known based on facial recognition data 152 from database 55, then guest 300 is recognized guest 320. Recognized guest 320 will not increase reward counter 102. A time limit precludes incrementing reward counter 102. Facial recognition data 152 can be used to compare each new facial detection of guest 300 to determine whether guest 300 is recognized, meaning that the guest 300 has approached to display 200 or camera 502 already. In a possible embodiment, recognized guest 320 (FIG. 9) can have repeated appearances which will not increase reward counter 102 unless the operator set a time limit to prevent repeated approaches to abuse reward counter 102. Facial recognition data 152 can encourage later use or repeat business, and another chance for rewards 310. A benefit of facial recognition in connection with the present invention is to encourage repeat business periodically through the reward system, while minimizing or preventing repeated appearances by a particular guest which can cause too high counts (employees, staff, etc.) or abuses of the rewards within a managed, preset time limit, e.g., 2 to 4 hours. Thereby, increment reward counter step 3006 (FIG. 3) can avoid incrementing during the time limit when a guest reappears and should not be counted toward the reward counter 102.

One having ordinary level of skill in the pertinent art would know how to incorporate the elements of the present invention to enable its use based on this specification without undue experimentation. One having ordinary level of skill in the pertinent art would know how to make and use the invention based on the disclosure of this specification. The present invention can be implemented on an operating system, including by way of non-limiting illustration, on Android, iOS, Windows, Unix variant, or any other operating system now known or future equivalent.

### CONCLUSION

In summary, the present invention provides a system for reward signage suitable for a retail, hospitality or other environments using a display, camera and reward system.

The present invention also provides a system to simultaneously check temperature while providing signage for display interaction, and reward signage suitable for a retail, hospitality or other environments using a display, scanner, camera and sign with a configurable temperature threshold.

The foregoing description of the preferred embodiments of the invention has been presented for the purposes of illustration and description. It is not intended to be exhaustive or to limit the invention to the precise form disclosed. Many modifications and variations are possible in light of the above teaching, it is intended that the scope of the invention are not, and need not be, limited by this detailed description, but by the claims and the equivalents to the claims which relate to the present invention. Use of punctuation and any articles “a” or “the” in reference to matter claimed shall be construed broadly to uphold the appended claims and equivalents thereto. This specification shall be construed broadly to uphold the claims and equivalents thereto, as set forth by the claims appended hereto.

What is claimed is:

1. A reward system, comprising:
a display;
a camera; and
a reward.

2. the system of claim 1, further comprising:
a snapshot is taken of a guest prior to providing the reward.

3. the system of claim 1, further comprising:
a reward counter increments by a facial recognition of a guest.

4. the system of claim 3, further comprising:
the reward is made obtainable when the reward counter reaches a reward winning number.

5. the system of claim 4, wherein:
a reward nominal number comprises a preset singular number.

6. the system of claim 5, wherein:
the reward winning number comprises a summation of the reward nominal number and a random number range.

7. the system of claim 5, wherein:
a snapshot is taken by the camera when the reward counter reaches the reward winning number.

8. the system of claim 6, further comprising:
the reward is obtainable by an at least one selected from: a QR code, an electronic notification, or a printer receipt.

9. the system of claim 1, further comprising:
a temperature scanner.

10. the system of claim 9, wherein:
the snapshot has a temperature reading associated with the reward.

11. the system of claim 9, wherein:
the snapshot comprises a temperature reading associated with a guest.

12. the system of claim 2, further comprising:
a facial detection of the guest.

13. the system of claim 12, wherein:
the facial detection is checked against a database of facial recognition data to determine whether the new facial detection data is a recognized guest.

14. the system of claim 13, wherein:
a guest is recognized based on a prior facial recognition data stored in the database.

15. the system of claim 5, further comprising:
a recognized guest will not increase the reward counter.

16. the system of claim 5, further comprising:
a time limit precludes incrementing the reward counter.

17. A temperature checking system that rewards guests, comprising:
a temperature scanner;
a display; and
a reward presented on the display.

18. the system of claim 17, further comprising:
a temperature reading is taken by the temperature scanner.

19. the system of claim 18, further comprising:
a possible fever indicator is generated where the temperature reading is not below a preset temperature threshold.

20. A method for fever detection and rewards, comprising:
setting a reward counter to designate when a reward will be given after an “n” number of temperature readings are taken where “n” is the reward counter.

21. the method of claim 20, further comprising:
obtaining a temperature reading.

22. the method of claim 21, wherein:
the temperature reading is compared against a possible fever threshold.

23. the method of claim 22, further comprising:
generating a notification comprising a snapshot taken at a time when a reward winning number is reached.

24. the method of claim 23, further comprising:
notifying the winner to claim the reward.

25. the method of claim 23, further comprising:
notifying a manager of a winner for the reward with the snapshot.

26. the method of claim 25, further comprising:
notifying a manager with the temperature reading.
